SEQUENCE LISTING (4 sequences)

SEQ ID NO: 1 - DNA, 23 bp, Artificial Sequence
  Synthetic primer
agcctcattctgcagcttcagca

SEQ ID NO: 2 - DNA, 25 bp, Artificial Sequence
  Synthetic primer
tccgtcctctgttaacggatcctta

SEQ ID NO: 3 - protein, 680 aa, Geobacillus stearothermophilus
AGNLNKVNFTSDVVYQIVVDRFVDGNTSNNPSGALFSSGCTNLRKYCGGDWQGIINKINDGYLTDMGVTAIWISQPVENVFSVMNDASGSASYHGYWARDFKKPNPFFGTLSDFQRLVDAAHAKGIKVIIDFAPNHTSPASETNPSYMENGRLYDNGTLLGGYTNDANMYFHHNGGTTFSSLEDGIYRNLFDLADLNHQNPVIDRYLKDAVKMWIDMGIDGIRMDAVKHMPFGWQKSLMDEIDNYRPVFTFGEWFLSENEVDANNHYFANESGMSLLDFRFGQKLRQVLRNNSDNWYGFNQMIQDTASAYDEVLDQVTFIDNHDMDRFMIDGGDPRKVDMALAVLLTSRGVPNIYYGTEQYMTGNGDPNNRKMMSSFNKNTRAYQVIQKLSSLRRNNPALAYGDTEQRWINGDVYVYERQFGKDVVLVAVNRSSSSNYSITGLFTALPAGTYTDQLGGLLDGNTIQVGSNGSVNAFDLGPGEVGVWAYSATESTPIIGHVGPMMGQVGHQVTIDGEGFGTNTGTVKFGTTAANVVSWSNNQIVVAVPNVSPGKYNITVQSSSGQTSAAYDNFEVLTNDQVSVRFVVNNATTNLGQNIYIVGNVYELGNWDTSKAIGPMFNQVVYSYPTWYIDVSVPEGKTIEFKFIKKDSQGNVTWESGSNHVYTTPTNTTGKIIVDWQN

SEQ ID NO: 4 - DNA, 2040 bp, Artificial Sequence
  Nucleotide sequence of the synthetic gene for expression of Geobacillus stearothermophilus CGTase
gcaggcaacctcaacaaagttaattttacgagcgatgtggtctaccagattgtggttgaccgctttgtcgacggaaacacaagcaataaccctagcggcgcacttttcagttctggatgcaccaatcttcgtaaatattgtggcggagattggcaaggcattataaataagattaatgacggttacttaaccgatatgggagtgacggccatctggatatctcagcctgtcgaaaatgtattttccgttatgaatgatgcatcaggctcagcttcgtaccacggttattgggcgcgtgatttcaagaagcctaaccctttcttcggaactcttagtgattttcagaggctcgttgatgcagctcacgcaaaaggcattaaggtcattatagactttgcaccgaaccatacatctcctgccagtgagacaaatccgtcatatatggaaaacggtaggttgtatgataatgggacgttgttgggtggctacacaaacgatgcgaatatgtatttccatcataatggtggaactacattttctagccttgaggatggcatttatcgaaatttattcgatctcgccgatctcaaccatcagaacccagtaatcgatcggtatttaaaagacgcggttaaaatgtggattgatatggggatagatgggattaggatggacgcagtgaagcatatgccgttcggttggcaaaaatcgttaatggatgagattgacaattaccggccagtatttacgtttggtgagtggtttctctcggaaaatgaagttgatgctaataaccattattttgcaaatgaatcagggatgtccttgctggatttcagatttggtcagaaacttaggcaggtgctcaggaacaactctgataactggtatggttttaatcaaatgattcaggatacagcatcagcgtacgacgaggtcttggaccaggttactttcatagacaaccacgatatggaccggtttatgatcgatggcggagatcctcgaaaggttgatatggctttagcggtcttgttgacttcccggggcgttccaaacatctactatggcacggaacagtatatgacaggtaacggagatcctaataaccgcaaaatgatgtcgtcgttcaacaagaacacaagagcgtatcaagttattcaaaaactttcttccctgaggcggaataatccagcactggcttatggcgatacagaacaacgttggattaacggtgatgtctatgtgtacgagcgtcaatttggaaaagacgtcgtgttagttgcggtgaatcgatccagcagctctaactattcaattacaggattgttcactgccttgcctgctggtacatataccgatcagcttggaggactgctggacggcaacacaatacaggtaggatctaatgggtcagtaaatgcgttcgatttaggtccgggggaagtcggcgtttgggcatatagcgccacagaaagcacacctattattggacatgtggggcctatgatgggacaggtaggtcaccaagttacaattgatggagagggctttggcacgaatacaggcacagttaagtttggaacaacagcagctaatgtcgtaagttggtcgaataatcagatcgtggtcgccgtgccgaatgtgtctccgggaaaatataatatcacagttcaaagctcctccggacaaacctcagcggcctatgataattttgaagtcctcacgaacgatcaggtaagtgttcgctttgtcgtaaacaatgccacgacgaatcttgggcagaacatatatattgtcggaaatgtatatgaattgggaaattgggacacttcaaaggctatcggaccgatgtttaaccaggttgtatattcataccctacatggtacattgacgtgagcgttccggaaggcaaaacgatcgaattcaaatttatcaagaaagacagtcagggcaatgtaacgtgggagtcaggttccaatcatgtgtatacaaccccgacaaatacaacaggtaaaatcatcgttgactggcagaat

(19) United States
(12) Patent Application Publication
(10) Pub. No.: US 2011/0312064 A1
(43) Pub. Date: Dec. 22, 2011

(54) METHODS OF REMOVING OILY STAINS FROM FABRICS

(75) Inventors: Christian D. Adams, San Francisco, CA (US); Katherine D. Collier, Los Altos, CA (US); Thjs Kaper, Half Moon Bay, CA (US); Brian F. Schmidt, Half Moon Bay, CA (US)

(73) Assignee: DANISCO US INC., Palo Alto, CA (US)

(21) Appl. No.: 13/132,071

(22) PCT Filed: Nov. 30, 2009
(86) PCT No.: PCT/US09/66102

§ 371 Date: Aug. 22, 2011

Related U.S. Application Data
(60) Provisional application No. 61/118,842, filed on Dec. 1, 2008.

(51) Int. Cl. C12S 11/00; C11D 3/60

(52) U.S. Cl. 435/263; 510/337; 510/321; 510/320

(57) ABSTRACT

Described are compositions and methods for removing oily stains from fabrics by treating the fabrics with cyclodextrins. Cyclodextrins can be added to the fabrics or generated in situ by converting a substrate of starch or dextrin with cyclomaltodextrin glucanotransferase.

### PRIORITY

The present application claims priority to U.S. Provisional Patent Application Ser. No. 61/118,842, filed on Dec. 1, 2008, which is hereby incorporated by reference.

### TECHNICAL FIELD

The present compositions and methods related to removing oily stains from fabrics by treating the fabrics with cyclodextrins. Exogenous cyclodextrins can be added to the fabrics or generated in situ by converting a substrate of starch or dextrin with cyclomaltodextrin glucanotransferase.

### BACKGROUND

Modern laundry detergent and/or fabric care compositions include a complex mixture of active ingredients, including surfactants, enzymes (proteases, amylases, lipases, and/or celluloses), bleaching agents, builder systems, suds suppressors, soil-suspending agents, soil-release agents, optical brighteners, softening agents, dispersants, dye transfer inhibition compounds, abrasives, bactericides, perfumes, and the like.

However, while an improvement over laundry detergents of years past, even modern laundry detergents do not provide a satisfactory solution for oily soil removal, particularly fatty acid removal. Lipolytic enzymes, including lipases and cutinases, have been employed in detergent cleaning compositions for the removal of oily stains. However, lipase and cutinase react with triglycerides to generate fatty acids, which are not easily removed from fabrics. As a result, a large portion of the fatty acids generated by lipases remain on the fabrics, thwarting cleaning efforts. Fatty acids may also physically or chemically inhibit the activity of lipase and cutinase, thus making the removal of oily stains even more problematic.

There remains a need for more efficient means for removing oily stains, particularly fatty acids, from fabrics.

### SUMMARY OF THE INVENTION

The present invention relates to methods for removing oily stains from fabrics by treating the fabrics with cyclodextrins. Cyclodextrins can be added to the fabrics or can be generated in situ by converting a substrate of starch or dextrin with cyclomaltodextrin glucanotransferase (“CGTase”). In one aspect, a method for removing oily stains from fabrics is provided, comprising the steps of: (i) identifying fabrics having oily stains; and (ii) treating the fabrics with a washing solution comprising cyclomaltodextrin glucanotransferase (CGTase) and a substrate of starch or dextrin to produce cyclodextrins in situ; wherein the cyclodextrins remove the oily stains from the fabrics.

In some embodiments, the washing solution further comprises a lypolytic enzyme. In some embodiments, the lypolytic enzyme is a lipase or a cutinase. In some embodiments, the oily stain comprises tryglycerides that are hydrolyzed to fatty acids by the lypolytic enzyme, and wherein the cyclodextrins prevent the deposition of the fatty acids on the fabric. In some embodiments, the oily stain comprises tryglycerides that are hydrolyzed to fatty acids by the lypolytic enzyme, and the cyclodextrins remove the fatty acids from the fabric.

In some embodiments, the washing solution further comprises a surfactant, hydrolytic enzyme, builder, bleaching agent, bleach activator, bluing agent, fluorescent dye, caking inhibitor, masking agent, antioxidant, or solubilizer.

In a related aspect, a method for removing oily stains from fabrics is provided, comprising the steps of: (i) identifying fabrics having oily stains; and (ii) treating the fabrics with a washing solution comprising cyclodextrins; wherein the cyclodextrins remove the oily stains from the fabrics.

In some embodiments, the washing solution further comprises a lypolytic enzyme. In some embodiments, the lypolytic enzyme is a lipase or a cutinase. In some embodiments, the oily stain comprises tryglycerides that are hydrolyzed to fatty acids by the lypolytic enzyme, and the cyclodextrins prevent the deposition of the fatty acids on the fabric. In some embodiments, the oily stain comprises tryglycerides that are hydrolyzed to fatty acids by the lypolytic enzyme, and the cyclodextrins remove the fatty acids from the fabric.

In some embodiments, the washing solution further comprises a surfactant, hydrolytic enzyme, builder, bleaching agent, bleach activator, bluing agent, fluorescent dye, caking inhibitor, masking agent, antioxidant, or solubilizer.

In another aspect, a laundry composition for removing oily stains comprising tryglycerides from fabric is provided, the composition comprising: (i) a lypolytic enzyme for generating fatty acids from tryglycerides present in an oily stain; and (ii) cyclodextrins for removing the fatty acids from the fabric or preventing the fatty acids from depositing on the fabric. In some embodiments, the cyclodextrins are generated in situ using cyclomaltodextrin glucanotransferase (CGTase) and a substrate of starch or dextrin.

In a related aspect, a laundry composition for removing oily stains comprising tryglycerides from fabric is provided, the composition comprising: (i) a lypolytic enzyme for generating fatty acids from tryglycerides present in an oily stain; and (ii) glucanotransferase (CGTase) and a substrate of starch or dextrin for producing cyclodextrins for removing the fatty acids from the fabric or preventing the fatty acids from depositing on the fabric.

In some embodiments, the CGTase is from Geobacillus stearothermophilus. In further embodiments, the CGTase is from a Bacillus spp. In some embodiments, the CGTase has at least 80%, at least 85%, at least 90%, at least 91%, at least 92%, at least 93%, at least 94%, at least 95%, at least 96%, at least 97%, at least 98%, or even at least 99% sequence identity to the amino acid sequence of SEQ ID NO: 3.

In some embodiments, the composition further comprising a surfactant, hydrolytic enzyme, builder, bleaching agent, bleach activator, bluing agent, fluorescent dye, caking inhibitor, masking agent, antioxidant, or solubilizer.

In another aspect, a method is provided comprising the steps of: identifying fabrics having oily stains, treating the fabrics with a washing solution comprising cyclomaltodextrin glucanotransferase and a substrate of starch or dextrin, and removing the oily stains from the fabrics. In addition to CGTase and the substrate, the washing solution in general further contains one or more components of a detergent composition such as surfactants, hydrolytic enzymes, builders, bleaching agents, bleach activators, bluing agents, fluorescent dyes, caking inhibitors, masking agents, antioxidants, and solubilizers. In the washing solution, the concentration of CGTase is generally 0.01-10 mg/L, preferably 0.1-5 mg/L, and more preferably 0.5-2 mg/L. The concentration of the substrate is generally 0.5-50 g/L, and preferably 1-5 g/L. In preferred embodiments, the washing solution further comprises a lipolytic enzyme, such as a lipase or a cutinase.

In another aspect, a method is provided comprising the steps of: identifying fabrics having oily stains, treating the fabrics with a washing solution comprising cyclodextrin, and removing the oily stains from the fabrics. In addition to cyclodextrin, the washing solution in general further contains one or more components of a detergent composition. In the washing solution, the concentration of cyclodextrin is generally 0.01-2%, preferably 0.1-1%, and more preferred 0.2-0.4% (w/v). In preferred embodiments, the washing solution further comprises a lipolytic enzyme, such as a lipase or a cutinase.

These and other aspects and embodiments of the compositions and methods are further described, below.

### BRIEF DESCRIPTION OF THE DRAWINGS

FIG. 1 is a graph showing the ability of rGsCGTase to generate cyclodextrin from dextrin either in solution, or in the presence of a cotton microswatch, or a cotton microswatch soaked with fatty acids (10 mM citrate, pH 6, 0.5% dextrin, 60° C., 30 min.).

FIG. 2 is a graph showing the amount of octanoic acid (mM) remaining on cloth and in solution, after incubation with increasing amounts of alpha-cyclodextrin.

FIG. 3 is a graph showing the detection of octanoic acid remaining on cloth after incubation with increasing amounts of rGsCGTase/dextrin or alpha-cyclodextrin (10 mM citrate, pH 6, 0.5% dextrin, 60° C., 18 hr.).

FIG. 4 is a graph showing the detection of oleic acid remaining on cloth after incubation with increasing amounts of rGsCGTase/dextrin or alpha-cyclodextrin (10 mM citrate, pH 6, 0.5% dextrin, 60° C., 18 hr.).

### DETAILED DESCRIPTION

### Definitions

As used herein, “alpha amylases” are α-1,4-glucan-4-glucanohydrolases (E.C. 3.2.1.1) and are enzymes that cleave or hydrolyze internal α-1,4-glycosidic linkages in starch (e.g. amylopectin or amylose polymers).

As used herein, “cutin” is one of two waxy polymers that are the main components of the plant cuticle which covers all aerial surfaces of plants. Cutin consists of hydroxy-fatty acids and their derivatives which are interlinked via ester bonds, forming a polyester polymer of indeterminate size. There are two major monomer families of cutin, the C16 and C18 families. The C16 family consists mainly of 16-hydroxypalmitate and 9,16 or 10,16-dihydroxypalmitate. The C18 family consists mainly of 18-hydroxyoleate, 9,10-epoxy-18-hydroxystearate, and 9,10,18-trihydroxystearate.

As used herein, “dextrins” are short chain polymers of glucose (e.g., 2 to 10 units).

As used herein, the term “detergent composition” refers to a mixture which is intended for use in a wash medium for the laundering of soiled fabrics. Detergent compositions in general contain surfactants, hydrolytic enzymes, builders, bleaching agents, bleach activators, bluing agents, fluorescent dyes, caking inhibitors, masking agents, antioxidants, and/or solubilizers.

As used herein, the term “fatty acid” refers to a carboxylic acid derived from or contained in an animal or vegetable fat or oil. All fatty acids are composed of a chain of alkyl groups containing from 4-22 carbon atoms and characterized by a terminal carboxyl group —COOH. Fatty acids may be saturated or unsaturated, and solid, semisolid, or liquid.

As used herein, a “liquefact,” also called a soluble starch substrate or a liquefied substrate, is a whole ground grain slurry containing a thermostable alpha-amylase that has been subjected to high temperature liquefaction resulting in a soluble substrate for saccharification and fermentation or simultaneous saccharification and fermentation. High temperature is a temperature higher than the gelatinization temperature of the grain.

As used herein, “liquefaction” or “liquefy” means a process by which starch is converted to shorter chain and less viscous dextrins.

As used herein, the term “oligosaccharide” refers to any compound having 2 to 10 monosaccharide units joined in glycosidic linkages. These short chain polymers of simple sugars include dextrins.

As used herein, the term “slurry” refers to an aqueous mixture comprising insoluble solids, (e.g. granular starch).

As used herein, the term “starch” refers to a material comprised of the complex polysaccharide carbohydrates of plants, i.e., amylose and amylopectin with the formula (C₆H₁₀O₅)ₓ, wherein x can be any number. An object of the starch liquefaction process is to convert a slurry of starch polymer granules into a solution of shorter chain length dextrins of low viscosity. Commonly, the starch is liquefied by use of high temperature and enzymatic bioconversion. For example, a common enzymatic liquefaction process involves adding a thermostable bacterial alpha amylase (e.g. SPEZYME® PRIME and SPEZYME® FRED, SPEZYME® ETHYL (Danisco U.S., Inc, Genencor Division) or TERMAMYL SC, TERMAMYL SUPRA or TERMANYL 120L (Novozymes)) to a slurry comprising a substrate including starch and adjusting the pH to between 5.5 to 6.5 and the temperature to greater than 90° C.

As used herein, the term “surfactant” refers to any compound generally recognized in the art as having surface active qualities. Thus, for example, surfactants comprise anionic, cationic and nonionic surfactants such as those commonly found in detergents. Anionic surfactants include linear or branched alkylbenzenesulfonates; alkyl or alkenyl ether sulfates having linear or branched alkyl groups or alkenyl groups; alkyl or alkenyl sulfates; olefinsulfonates; and alkanesulfonates. Ampholytic surfactants include quaternary ammonium salt sulfonates, and betaine-type ampholytic surfactants. Such ampholytic surfactants have both the positive and negative charged groups in the same molecule. Nonionic surfactants may comprise polyoxyalkylene ethers, as well as higher fatty acid alkanolamides or alkylene oxide adduct thereof, fatty acid glycerine monoesters, and the like.

As used herein, the term “triglyceride” refers to any naturally occurring ester of a fatty acid and glycerol. Trigeycerides are the chief constituents of fats and oils. The have the general formula of CH₂(OOCR₁)CH(OOCR₂)CH₂(OOCR₃), where R₁, R₂, and R₃ are usually of different chain length.

As used herein, the term “variant” when used in reference to an enzyme (e.g. a CGTase, a lipase, a cutinase, or the like) means an enzyme derived from a naturally occurring enzyme (wild-type) but having a substitution, insertion or deletion of one or more amino acids as compared to the naturally occurring enzyme. A variant can have one or more altered properties compared to the wild-type such as but not limited to increased thermal stability, increased proteolytic stability, increased specific activity, broader substrate specificity, broader activity over a pH range or combinations thereof.

As used herein, the term “wild-type” as used herein refers to an enzyme naturally occurring (native) in a host cell.

As used herein, a “lipolytic enzyme” (E.C. 3.1.1) refers to any acyl-glycerol carboxylic ester hydrolase. Lipolytic enzymes include lipases (triacylglycerol acylhydrolases, E.C. 3.1.1.3) and cutinases (E.C. 3.1.1.50). Lipases have greater selectivity toward long chain triglycerides contained in fat than cutinases. Cutinase are, generally, lipolytic enzymes capable of hydrolyzing the substrate cutin, and greater selectivity toward short chain triglycerides contained in fat than lipases.

### Overview

Contemporary detergents do not effectively remove oily stains from fabrics, such as wool, cotton, polyester and polyester/cotton blends and other synthetic materials. Oily stains generally contain triglycerides and fatty acids. Fatty acids are particularly difficult to remove from fabrics. Lipases that are uses to hydrolize tryglycerides generate fatty acids, which excacerbates the problem with stain removal. The present compositions and methods are based on the observation that cyclodextrins are surprisingly effective in removing oily stains from fabrics. Exogenous cyclodextrins can be added to oily stains on fabrics or cyclodextrins can be generated in situ by the reaction of cyclomaltodextrin glucanotransferase (CGTase) with a substrate of dextrin or starch.

Accordingly, in one aspect, the present invention relates to cleaning compositions comprising cyclodextrins. In another aspect, the present invention relates to cleaning compositions capable of generating cyclodextrins in situ. In yet another aspect, the present invention is directed to methods for removing oily stains from fabrics. In one embodiment, the method comprises the steps of: identifying fabrics having oily stains, treating the fabrics with a washing solution comprising cyclodextrin, and removing the oily stains from the fabrics. In another embodiment, the method comprises the steps of: identifying fabrics having oily stains, treating the fabrics with a washing solution comprising cyclomaltodextrin glucanotransferase and a substrate of starch or dextrin, and removing the oily stains from the fabrics.

In some embodiments, oily stains on fabrics are pre-treated (i.e., spotted treated) with a composition comprising cyclodextrins prior to normal washing using a fabric laundering (i.e., washing) solution of composition, which may or may not further include cyclodextrins. Alternatively, oily stains on fabrics are treated with a single fabric laundering composition, without pre-treatment.

Optionally, a lipolytic enzyme such as a lipase or a cutinase is included in the washing solution such that the lipolytic enzyme degrades triglycerides to produce fatty acids, and cyclodextrins removes the fatty acids from the oily stain.

Exemplary cyclodextrins, lipases, and methods of use, are further described, below.

### Cyclodextrins

Cyclodextrins (sometimes called cycloamyloses) make up a family of cyclic oligosaccharides, composed of five or more α-D-glucopyranoside units linked 1-4, as in amylose/starch. The five-membered macrocycle is not natural. Typical cyclodextrins contain a number of glucose monomers ranging from six to eight units in a ring, creating a cone shape. α-cyclodextrin is a six-membered sugar ring molecule. β-cyclodextrin is a seven membered sugar ring molecule. γ-cyclodextrin is a eight-membered sugar ring molecule. Cyclodextrins are produced from starch or dextrin by means of enzymatic conversion.

Chemically, the production of cyclodextrins is relatively simple, and involves treatment of ordinary starch with a set of easily available enzymes. Commonly cyclomaltodextrin glucanotransferase (CGTase) is employed along with α-amylase. First starch is liquified either by heat treatment or using α-amylase, then CGTase is added for the enzymatic conversion. CGTases can synthesize all forms of cyclodextrins, thus the product of the conversion results in a mixture of the three main types of cyclic molecules, in ratios that are dependent on the enzyme.

Cyclodextrins can also be prepared by reacting CGTase with its substrate such as starch or dextrin directly without additional enzymes.

Cyclomaltodextrin glucanotransferase

Cyclomaltodextrin glucanotransferase (CGTase), EC 2.4.1.19, is an enzyme that cyclizes part of a 1,4-α-D-glucan chain by formation of a 1,4-α-D-glucosidic bond and has the systematic name of 1,4-α-D-glucan 4-α-D-(1,4-α-D-glucano)-transferase (cyclizing). CGTases reversibly form cyclomaltodextrins of various sizes (6, 7, 8 glucose units) from starch and similar substrates such as dextrin. In addition to the cyclization activity, CGTases can also hydrolyze linear maltodextrins without cyclizing (EC 2.4.1.25, 4-alpha-glucanotransferase). The hydrolysis activity of CGTase allows it to metabolize starch into pieces small enough to be cyclized.

Cyclomaltodextrin glucanotransferases useful according to the invention can be a wild-type cyclomaltodextrin glucanotransferase, a variant or fragment thereof, or a hybrid cyclomaltodextrin glucanotransferase which is derived from for example a catalytic domain from one microbial source and a starch binding domain from another microbial source. Alternatively, the cyclomaltodextrin glucanotransferase can be a variant that has been engineered to be acid or alkaline stable.

Suitable cyclomaltodextrin glucanotransferases for the purpose of the present invention include CGTases from Bacillus species and Geobacillus species. Examples of CGTases include those obtained from microbial strains, including but not limited to strains of Bacillus spp. (e.g. B. agaradhaerens, B. alcalophilus, B. autolyticus, B. cereus, B. circulans, B. clarkii, B. coagulans, B. firmus, B. halophilus, B. lentus, B. licheniformis, B. macerans, B. megaterium, B. ohbensis, Bacillus spp. strains 1-1, 1011, 17-1, 38-2, 6.6.3, and B1018, B. subtilis; Geobacillus (formerly Bacillus) stearothermophilus; Klebsiella spp. (e.g., K. oxytoca, K. pneumoniae); Micrococcus spp. (e.g., M. luteus); Thermoactinomyces spp.; Thermoanaerobacter spp. (e.g., T. thermosulfurigenes); Thermococcus spp.; Xanthomonas spp. (e.g., X. axonopodis, X. campestris); Anaerobranca spp.; Brevibacillus brevis.; Escherichia coli; Paenibacillus spp. (e.g., P. campinasensis, P. illinoisensis, P. macerans); and Streptococcus spp.

Commercially available cyclomaltodextrin glucanotransferases useful for the invention include, but are not limited to: cyclomaltodextrin glucanotransferase (CGTase Thermophilic, US Biological); cyclomaltodextrin glucanotransferase “Amano” (Amano, Inc.).

CGTase may be wild-type enzymes or variants or fragements, thereof, having CGTase activity. Exemplary variant CGTase include conservative amino acid substitutions, or conservative or non-conservative substitutions that modulate functionality. In some embodiments, the CGTase has at least 80%, at least 85%, at least 90%, at least 91%, at least 92%, at least 93%, at least 94%, at least 95%, at least 96%, at least 97%, at least 98%, or even at least 99% sequence identity to a reference amino acid sequence.

### Lipolytic Enzymes

Lipases useful according to the invention include wild-type lipases as well as variants and fragments of lipases having enzyme activity. Extracellular lipases (E.C. 3.1.1.3) are produced by a wide variety of microorganisms such as fungi. Suitable microbial lipases include those disclosed in U.S. Pat. No. 3,950,277. These lipases were obtained from such diverse microorganisms as Pseudomonas, Aspergillus, Pneumococcus, Staphylococcus, Mycobacterium tuberculosis, Mycotorula lipolytica and Sclerotinia. Lipases obtained from Streptomyces species, e.g., Streptomyces rimosus or Streptomyces coelicolor, or Corynebacterium, e.g., Corynebacterium efficiens, or variants or homologues thereof, may also be used.

Examples of using lipases in detergent compositions are disclosed in. e.g., EP 463100 (Pseudomonas alcaligenes), EP 0218272 (Pseudomonas pseudoalcaligenes), EP 0214761 (Pseudomonas cepacia), EP 0258068 (Thermomyces), EP 206390 (Pseudomonas Chromobacter, Pseudomonas fluorescens, Pseudomonas fragi, Pseudomonas nitroreducens, Pseudomonas gladioli, and Chromobacter viscosum), EP 0652946 (lipase variant), EP 0 130 064 (Fusarium oxysporum, WO 90/09446 (Fusarium solanii var. pisi.), and U.S. Pat. No. 5,990,069 (Fusarium solanii). The lipases disclosed in the above references are suitable for use in the present invention.

Cutinases are lipolytic enzymes capable of hydrolyzing the substrate cutin. Cutinases useful according to the invention can be a wild-type cutinase, a variant, or a fragment having the enzyme activity. Cutinases are produced by a wide variety of microorganisms such as fungi. Suitable cutinases for the present invention have been disclosed, for example, in Kolattukudy, P. E. in “Lipases”, Ed. B. Borgstrom and H. L. Brockman, Elsevier 1984, 471-504. The amino acid sequence and the crystal structure of a cutinase of Fusarium solani pisi have been described (Longhi, S. et al., J. Mol. Biol., 268:779-99, 1997). The amino acid sequence of a cutinase from Humicola insolens has also been published (U.S. Pat. No. 5,827,719).

Suitable cutinases include a number of variants of the cutinase from Fusarium solani pisi that are disclosed in WO 94/14963; WO 94/14964; WO 00/05389; Masaki et al. (2005) Appl Environ Microbiol. 71: 7548-50; van Gemeren et al. (1998) Appl. Environm. Microbiol. 64:2794-99; Longhi et al. (1996) Proteins: Structure, Function and Genetics 26:442-58; Juffer et al. (1996) J. of Computational Chemistry 17:1783-1803; Petersen et al. (1993) Protein Engineering 6:157-65; Creveld et al. (1998) Proteins: Structure, Function, and Genetics 33:253-64; Petersen et al. (1998) J. of Biotechnology 66:11-26; Nicolas et al. (1996) Biochemistry 35:398-410; Flipsena et al. (1999) Chemistry and Physics of Lipids 97:181-191; Lesk et al. (1998) Proteins: Structure, Function, and Genetics 31:320-28; Longhi and Cambillau (1999) Biochimica et Biophysica Acta 1441:185-96; Sagt et al. (1998) Appl. Environm. Microbiol. 64:316-24; Bluteau et al. (1999) BioTechniques 27:1102-08; and U.S. Pat. No. 6,960,459 (fungal cutinase variants having improved thermostability). A cutinase obtained from Pseudomonas mendocina or a variant or homologue thereof may also be used.

Cyclodextrins Generated in situ

In some aspect, the present methods involve generating cyclodextrins in situ. Such methods generally include the steps of identifying fabrics having oily stains, treating the fabrics with a washing solution comprising cyclomaltodextrin glucanotransferase and a substrate of starch or dextrin, and removing the oily stains from the fabrics. In this manner, cyclodextrins are generated in situ by converting the substrate with CGTase, and the generated cyclodextrins are then available to react with free fatty acids or monoglycerides by inclusion of the fatty acids or monoglycerides to form a water soluble inclusion complex.

In addition to CGTase and the substrate, the washing solution may further contain one or more components of a detergent composition, such as surfactants, hydrolytic enzymes, builders, bleaching agents, bleach activators, bluing agents, fluorescent dyes, caking inhibitors, masking agents, antioxidants, and solubilizers. The washing solution should have a pH range suitable for the CGTase activity, which is generally about 4-9, preferably about 5-8, and more preferably about 5-6. The treatment temperature range suitable for the CGTase activity is in general about 20-60° C., preferably about 30-60° C., and more preferably about 50-60° C.

In the washing solution, the concentration of CGTase is generally about 0.01-10 mg/L, preferably about 0.1-5 mg/L, and more preferably about 0.5-2 mg/L. The concentration of the substrate is generally about 0.5-50 g/L, and preferably about 1-5 g/L.

In preferred embodiments, the washing solution further comprises a lipolytic enzyme, such as a lipase or a cutinase. The concentration of the lipolytic enzyme in the washing solution is generally about 0.01-10 mg/L, preferably about 0.1-5 mg/L, and more preferably about 0.5-2 mg/L.

In one embodiment, the washing solution is prepared by dissolving a solid detergent composition comprising CGTase and the substrate in an aqueous solution such as water. The solid detergent composition may be a dry powder and/or granular form. The solid detergent contains CGTase, the substrate, and one or more components of a detergent composition such as surfactants, hydrolytic enzymes, builders, bleaching agents, bleach activators, bluing agents, fluorescent dyes, caking inhibitors, masking agents, antioxidants, and solubilizers. The CGTase amount in the solid detergent is generally about 0.001-1%, preferably about 0.01-0.5%, and more preferably about 0.05-0.2% (w/w). The weight ratio of substrate to CGTase in the solid detergent is from about 500-10,000 to 1, preferably about 1000-5,000 to 1.

In another embodiment, the washing solution is prepared by mixing (a) a solid detergent composition comprising CGTase and (b) a substrate in an aqueous solution such as water. The solid detergent contains CGTase and one or more components of a detergent composition. The CGTase amount in the solid detergent is generally about 0.001-1%, preferably about 0.01-0.5%, and more preferably about 0.05-0.2% (w/w). The solid detergent optionally contains a lipolytic enzyme such as lipase, in an amount of about 0.001-1%, preferably about 0.01-0.5%, and more preferably about 0.05-0.2% (w/w). In this embodiment, the substrate is separate from the detergent composition. The substrate can either be provided in a separate container, or provided from the soiled fabrics, which contain a large amount of starch or dextrin, e.g., pasta.

In a further embodiment, the washing solution is prepared by mixing (a) a liquid detergent composition comprising cyclomaltodextrin glucanotransferase and (b) a substrate (often in a solid form) in water. In the liquid detergent composition, CGTase is in an amount of about 0.001-1%, preferably about 0.01-0.5%, and more preferably about 0.05-0.2% (w/v). The liquid detergent composition is in general diluted about 200-5,000 fold, preferably about 500-2,000 fold, and more preferably about 1000 fold, to prepare a washing solution in a washing machine. In this embodiment, the substrate is separate from the liquid detergent composition. The substrate can either be provided in a separate container, or provided from the soiled fabrics, which contain a large amount of starch or dextrin, e.g., pasta.

The solid detergent or the liquid detergent optionally contains a lipolytic enzyme such as lipase or cutinase, in an amount of about 0.001-1%, preferably about 0.01-0.5%, and more preferably about 0.05-0.2% (w/w). The lipolytic enzyme degrades triglycerides in the oily stains, which makes the removal of oily stains more effectively. Fatty acids produced from the triglycerides are removed from the fabric, or prevented from depositing on the fabric, by the cyclodextrins.

### Cyclodextrin Provided Directly

In another aspect, the present methods comprise the steps of: identifying fabrics having oily stains, treating the fabrics with a washing solution comprising exogenous cyclodextrins (i.e., not generated in situ), and removing the oily stains from the fabrics.

In addition to cyclodextrins, such washing solutions may, in general, further contain one or more conventional detergent composition components, such as surfactants, hydrolytic enzymes, builders, bleaching agents, bleach activators, bluing agents, fluorescent dyes, caking inhibitors, masking agents, antioxidants, solubilizers, and the like. The washing solution has a pH range generally about 4-11, preferably about 5-10, and more preferably about 8-9. The treatment temperature is in general about 15-60° C., preferably about 20-50° C., and more preferably about 30-40° C.

In the washing solution, the concentration of cyclodextrin is generally about 0.01-2%, preferably about 0.1-1%, and more preferably about 0.2-0.4% (w/v). The washing solution is prepared by dissolving a solid detergent comprising cyclodextrin in an aqueous solution such as water. The solid detergent often contains one or more detergent components such as surfactants, hydrolytic enzymes, builders, bleaching agents, bleach activators, bluing agents and fluorescent dyes, caking inhibitors, masking agents, antioxidants, solubilizers, and the like.

In another embodiment, the washing solution is prepared by mixing cyclodextrin and a solid detergent in an aqueous solution such as water. In yet another embodiment, the washing solution is prepared by mixing cyclodextrin and a liquid detergent in an aqueous solution such as water.

In a preferred embodiment, the washing solution further comprises a lipolytic enzyme, such as a lipase or a cutinase. The concentration of the lipolytic enzyme in the washing solution is generally about 0.01-10 mg/L, preferably about 0.1-5 mg/L, and more preferably about 0.5-2 mg/L. In such cases, the lipolytic enzyme degrades triglycerides in the oily stains, which makes the removal of oily stains more effective. Fatty acids produced from the triglycerides are removed from the fabric, or prevented from depositing on the fabric, by the cyclodextrins.

The present compositions and methods are described in further detail in the following examples which are not in any way intended to limit the scope of the invention as claimed. The following examples are offered to illustrate, but not to limit the claimed invention.

### EXAMPLES

In the experimental disclosure which follows, and above, the following abbreviations apply: ppm (parts per million); M (molar); mM (millimolar); μM (micromolar); nM (nanomolar); mol (moles); mmol (millimoles); μmol (micromoles); nmol (nanomoles); g (grams); mg (milligrams); μg (micrograms); pg (picograms); L (liters); ml and mL (milliliters); μl and μL (microliters); cm (centimeters); mm (millimeters); μm (micrometers); nm (nanometers); U (units); MW (molecular weight); sec (seconds); min(s) (minute/minutes); h(s) and hr(s) (hour/hours); ° C. (degrees Centigrade); QS (quantity sufficient); ND (not done); NA (not applicable); rpm (revolutions per minute); H₂O (water); dH₂O (deionized water); (HCl (hydrochloric acid); aa (amino acid); by (base pair); kb (kilobase pair); kD (kilodaltons); cDNA (copy or complementary DNA); DNA (deoxyribonucleic acid); ssDNA (single stranded DNA); dsDNA (double stranded DNA); dNTP (deoxyribonucleotide triphosphate); RNA (ribonucleic acid); MgCl₂ (magnesium chloride); NaCl (sodium chloride); w/v (weight to volume); v/v (volume to volume); OD (optical density); SDS (sodium dodecyl sulfate); Tris (tris(hydroxymethyl)aminomethane); HEPES (N-[2-Hydroxyethyl]piperazine-N-[2-ethanesulfonic acid]); HBS (HEPES buffered saline); Tris-HCl (tris[Hydroxymethyl]aminomethane-hydrochloride); DTT (1,4-dithio-DL-threitol); SA (sinapinic acid (s,5-dimethoxy-4-hydroxy cinnamic acid); TCA (trichloroacetic acid); Glut and GSH (reduced glutathione); HPLC (high pressure liquid chromatography); RP-HPLC (reverse phase high pressure liquid chromatography); and TLC (thin layer chromatography). Other abbreviations should be accorded their ordinary meaning as used in the art.

### Example 1

### Cloning and Expression of Cyclomaltodextrin Glucanotransferase (CGTase) from Geobacillus stearothermophilus

A cyclomaltodextrin glucanotransferase (CGTase; EC 2.4.1.19) enzyme was used in this study (SwissProt accession number P31797. Characteristic differences in the primary structure allow the discrimination of cyclodextrin glucanotransferases from alpha-amylases (Janecek, S. et al. Biochem J. 305 (Pt 2):685-86, 1995).

In this example, the construction of Bacillus subtilis strains expressing recombinant Geobacillus stearothermophilus cyclomaltodextrin glucanotransferase (rGsCGTase) is described. Synthetic DNA fragment GCM46 (produced by Gene Oracle, Mountain View, Calif.), containing a Geobacillus stearothermophilus CGTase synthetic gene with codons selected for expression in Bacillus host served as template DNA. The pHPLT vector (Solingen et al., Extremophiles 5:333-41, 2001) which contains the Bacillus licheniformis alpha-amylase (LAT) promoter and the LAT signal peptide (pre LAT) containing the PstI and HpaI restriction sites for cloning was used for expression of the gene. Primers pHPLT-PstI cloning F (5′-AGCCTCATTCTGCAGCTTCAGCA-3′; SEQ ID NO: 1) and cyclo HpaI R 5′-TCCGTCCTCTGTTAACGGATCCTTA-3′; SEQ ID NO: 2) were used to amplify the synthetic gene for sub-cloning (see, below). PCR was performed using 1 μL of template GCM46 DNA, 0.5 μM final concentration of each primer, 1.5 μL of 10 mM dNTP mix, and 1 μL of Pfu Ultra polymerase (Stratagene, La Jolla, Calif.) in a final volume of 50 μL using a MJ Research/Bio-Rad PTC-200 thermal cycler. PCR cycling conditions were as follows: 95° C. 2 min 1×, 95° C. 30 sec, 52° C. 30 sec, 72° C. 2 mM, 30×, then 72° C. 10 min final extension.

The amplified linear 2.0 kb DNA fragment was purified using QIAGEN® Qiaquick PCR purification kit Cat. No. 28106). The pHPLT vector and linear 2 kb PCR product were digested with PstI and HpaL The digested insert and vector were purified using a QIAGEN® Qiaquick PCR purification kit (Cat. No. 28106). Digested PCR insert and pHPLT vector were then ligated (Takara Mighty Mix ligase; Takara Bio USA, Madison, Wis.) for 20 hours at 16° C.

The ligation mixture was transformed into a B. subtilis strain (ΔaprE, ΔnprE, Δepr, ΔispA, Δbpr) and (degUHy32, oppA, ΔspoIIE3501, amyE::xylRPxylAcomKermC, (Δvpr, ΔwprA, Δmpr-ybfJ, ΔnprB). Transformation into B. subtilis was performed as described in WO 02/14490 (Bacillus Transformation, Transformants and Mutant Libraries). The B. subtilis transformants were selected on Luria agar plates supplemented with 10 mg/L neomycin. B. subtilis transformants harboring the pHPLT-rGsCGTase vector were typically grown in shake flasks at 37° C. for 60-72 hours at 250 rpm in a medium containing soytone, glucose, urea, MOPS and salts at pH 7.3 (Vogtentanz et al., Protein Expr Purif. 55:40-52, 2007). This growth resulted in the production of secreted CGTase.

The amino acid sequence of mature Geobacillus stearothermophilus CGTase is shown, below:

(SEQ ID NO: 3)
AGNLNKVNFTSDVVYQIVVDRFVDGNTSNNPSGALFSSGCTNLRKYC
GGDWQGIINKINDGYLTYDMGVTAIWISQPVENVFSVMNDASGSASY
HGYWARDFKKPNPFFGTLSDFQRLVDAAHAKGIKVIIDFAPNHTSPA
SETNPSYMENGRLYDNGTLLGGYTNDANMYFHHNGGTTFSSLEDGIY
RNLFDLADLNHQNPVIDRYLKDAVKMWIDMGIDGIRMDAVKHMPFGW
QKSLMDEIDNYRPVFTFGEWFLSENEVDANNHYFANESGMSLLDFRF
GQKLRQVLRNNSDNWYGFNQMIQDTASAYDEVLDQVTFIDNHDMDRF
MIDGGDPRKVDMALAVLLTSRGVPNIYYGTEQYMTGNGDPNNRKMMS
SFNKNTRAYQVIQKLSSLRRNNPALAYGDTEQRWINGDVYVYERQGF
KDVVLVAVNRSSSSNYSITGLFTALPAGTYTDQLGGLLDGNTIQVGS
NGSVNAFDLGPGEVGVWAYSATESTPIIGHVGPMMGQVGHQVTIDGE
GFGTNTGTVKFGTTAANVVSWSNNQIVVAVPNVSPGKYNITVQSSSG
QTSAAYDNFEVLTNDQVSVRFVVNNATTNLGQNIYIVGNVYELGNWD
TSKAIGPMFNQVVYSYPTWYIDVSVPEGKTIEFKFIKKDSQGNVTWE
SGSNHVYTTPTNTTGKIIVDWQN.

The nucleotide sequence of the synthetic gene for expression of Geobacillus stearothermophilus CGTase is shown, below:

(SEQ ID NO: 4)
GCAGGCAACCTCAACAAAGTTAATTTTACGAGCGATGTGGTCTACCA
GATTGTGGTTGACCGCTTTGTCGACGGAAACACAAGCAATAACCCTA
GCGGCGCACTTTTCAGTTCTGGATGCACCAATCTTCGTAAATATTGT
GGCGGAGATTGGCAAGGCATTATAAATAAGATTAATGACGGTTACTT
AACCGATATGGGAGTGACGGCCATCTGGATATCTCAGCCTGTCGAAA
ATGTATTTTCCGTTATGAATGATGCATCAGGCTCAGCTTCGTACCAC
GGTTATTGGGCGCGTGATTTCAAGAAGCCTAACCCTTTCTTCGGAAC
TCTTAGTGATTTTCAGAGGCTCGTTGATGCAGCTCACGCAAAAGGCA
TTAAGGTCATTATAGACTTTGCACCGAACCATACATCTCCTGCCAGT
GAGACAAATCCGTCATATATGGAAAACGGTAGGTTGTATGATAATGG
GACGTTGTTGGGTGGCTACACAAACGATGCGAATATGTATTTCCATC
ATAATGGTGGAACTACATTTTCTAGCCTTGAGGATGGCATTTATCGA
AATTTATTCGATCTCGCCGATCTCAACCATCAGAACCCAGTAATCGA
TCGGTATTTAAAAGACGCGGTTAAAATGTGGATTGATATGGGGATAG
ATGGGATTAGGATGGACGCAGTGAAGCATATGCCGTTCGGTTGGCAA
AAATCGTTAATGGATGAGATTGACAATTACCGGCCAGTATTTACGTT
TGGTGAGTGGTTTCTCTCGGAAAATGAAGTTGATGCTAATAACCATT
ATTTTGCAAATGAATCAGGGATGTCCTTGCTGGATTTCAGATTTGGT
CAGAAACTTAGGCAGGTGCTCAGGAACAACTCTGATAACTGGTATGG
TTTTAATCAAATGATTCAGGATACAGCATCAGCGTACAGCGAGGTCT
TGGACCAGGTTACTTTCATAGACAACCACGATATGGACCGGTTTATG
ATCGATGGCGGAGATCCTCGAAAGGTTGATATGGCTTTAGCGGTCTT
GTTGACTTCCCGGGGCGTTCCAAACATCTACTATGGCACGGAACAGT
ATATGACAGGTAACGGAGATCCTAATAACCGCAAAATGATGTCGTCG
TTCAACAAGAACACAAGAGCGTATCAAGTTATTCAAAAACTTTCTTC
CCTGAGGCGGAATAATCCAGCACTGGCTTATGGCGATACAGAACAAC
GTTGGATTAACGGTGATGTCTATGTGTACGAGCGTCAATTTGGAAAA
GACGTCGTGTTAGTTGCGGTGAATCGATCCAGCAGCTCTAACTATTC
AATTACAGGATTGTTCACTGCCTTGCCTGCTGGTACATATACCGATC
AGCTTGGAGGACTGCTGGACGGCAACACAATACAGGTAGGATCTAAT
GGGTCAGTAAATGCGTTCGATTTAGGTCCGGGGGAAGTCGGCGTTTG
GGCATATAGCGCCACAGAAAGCACACCTATTATTGGACATGTGGGGC
CTATGATGGGACAGGTAGGTCACCAAGTTACAATTGATGGAGAGGGC
TTTGGCACGAATACAGGCACAGTTAAGTTTGGAACAACAGCAGCTAA
TGTCGTAAGTTGGTCGAATAATCAGATCGTGGTCGCCGTGCCGAATG
TGTCTCCGGGAAAATATAATATCACAGTTCAAAGCTCCTCCGGACAA
ACCTCAGCGGCCTATGATAATTTTGAAGTCCTCACGAACGATCAGGT
AAGTGTTCGCTTTGTCGTAAACAATGCCACGACGAATCTTGGGCAGA
ACATATATATTGTCGGAAATGTATATGAATTGGGAAATTGGGACACT
TCAAAGGCTATCGGACCGATGTTTAACCAGGTTGTATATTCATACCC
TACATGGTACATTGACGTGAGCGTTCCGGAAGGCAAAACGATCGAAT
TCAAATTTATCAAGAAAGACAGTCAGGGCAATGTAACGTGGGAGTCA
GGTTCCAATCATGTGTATACAACCCCGACAAATACAACAGGTAAAAT
CATCGTTGACTGGCAGAAT

### Example 2

### Cyclodextrin Generation by rGsCGTase

In this example, the ability of rGsCGTase to generate cyclodextrin from dextrin either in solution or in the presence of a cotton microswatch or a cotton microswatch soaked with fatty acids was tested. Fatty acid soaked cotton microswatches were prepared as follows: Solutions of octanoic acid (Sigma C2875-100 ml) or oleic acid (Sigma O1008-5G) were made in buffer containing 50 mM HEPES, pH 6.2, 2% polyvinyl alcohol (Sigma 341584-25G poly(vinyl alcohol) to give a concentration of 6 mM octanoic acid and 8 mM oleic acid. 10 μL of these solutions were added to EMPA 221 cotton microswatches (0.5 cm diameter, TestFabrics, Inc) placed in the wells of a 96-well microtiter plate. The fatty acid solution was allowed to soak into the fabric for 20 minutes.

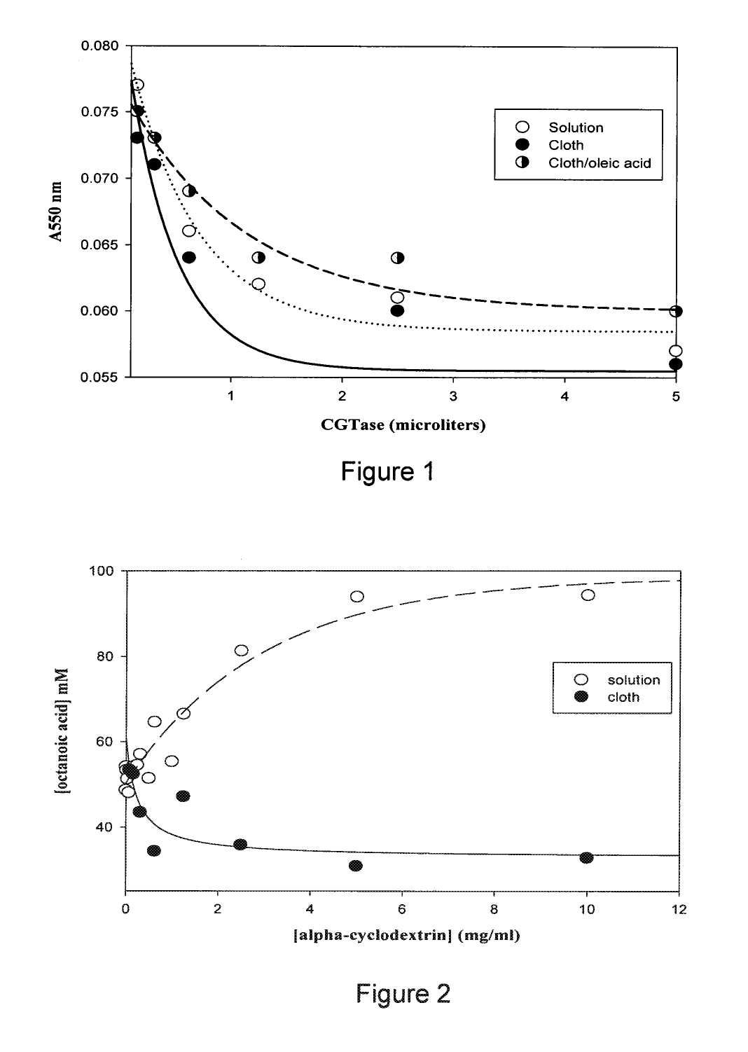

The general reaction conditions for the generation and detection of cyclodextrins from dextrin described in “Characterization of Thermoanaerobacter cyclomaltodextrin glucanotransferase immobilized on glyoxyl-agarose” by Tardioli et al., Enzyme and Microbial Technology 39:1270, 2006) were used. Recombinant GsCGTase enzyme was serially diluted in a 10 mM citrate, pH 6.0 buffer. The diluted enzymes were added to a microtiter plate containing 10 mM citrate, pH 6.0 buffer with 0.5% (w/v) dextrin (Dextrin from corn, Sigma, D2006-100G), in the presence or absence of unsoaked and oleic acid soaked cotton microswatches. Enzyme samples were incubated with the different substrates at 60° C. for 30 minutes. At the end of the incubation period, cyclodextrin generation was assayed by addition of 20 uL reaction products to 100 μL 6 μM phenolphthalein solution freshly prepared in 120 mM carbonate-bicarbonate, pH 10.5 buffer. Optical density of the solution was immediately measured at 550 nm. A decrease in absorbance signal indicates an increase in cyclodextrin present in solution. FIG. 1 shows the results of rGsCGTase converting dextrin to cyclodextrin under the conditions tested in these experiments.

### Example 3

### Fatty Acid Removal from Cloth by Cyclodextrin

In this example, the ability of cyclodextrin to remove fatty acid from cloth was tested. Increasing concentrations of alpha cyclodextrin (Sigma C4642-25G) were added to octanoic acid soaked microswatches in a 96-well microtiter plate. The plates were incubated at 20° C. for 20 min in 50 mM HEPES pH 8.2, 6 grains per gallon (gpg) hardness, and 2% gum arabic (Sigma G9752-500G). After incubation, the presence of fatty acids in solution and remaining on the cloth was detected using the HR Series NEFA-HR (2) NEFA kit (WAKO Diagnostics, Richmond, Va.) as indicated by the manufacturer.

The results are shown in FIG. 2. Addition of increasing amounts of alpha-cyclodextrin to octanoic acid soaked cotton microswatches resulted in an observed increase in fatty acids released in the solution.

### Example 4

### Fatty Acid Removal from Cloth by Dextrin and rGsCGTase

In this example, the ability of cyclodextrin generated by rGsCGTase to remove fatty acid from cloth was tested. Octanoic acid or oleic acid soaked microswatches were incubated in 100 μL of 10 mM citrate, pH 6.0 buffer in microtiter plates. 0.5% (w/v) dextrin was added to the wells containing the fatty-acid soaked microswatches. 10 μL of rGsCGTase enzyme serially diluted in 10 mM citrate, pH 6.0 buffer was added to these wells. Some wells containing the fatty acid soaked microswatches received increasing concentration of alpha cyclodextrin (positive control). The microtiter plates were incubated at 60° C. for 18 hours. Removal of fatty acids was measured by assaying fatty acids remaining on the cloth using the HR Series NEFA-HR (2) NEFA kit (WAKO Diagnostics, Richmond, Va.) as indicated by the manufacturer.

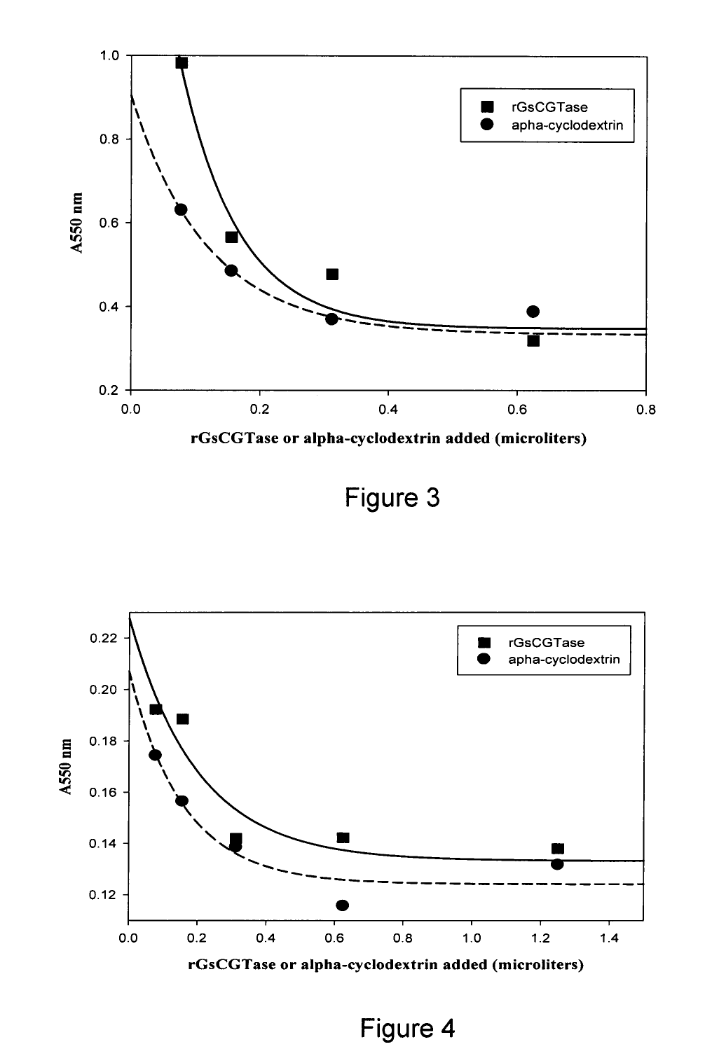

FIG. 3 shows the detection of octanoic acid remaining on cloth after incubation with increasing amounts of rGsCGTase/dextrin or alpha cyclodextrin. The results show that octanoic acid was significantly removed from cloth by rGsCGTase/dextrin or alpha cyclodextrin.

FIG. 4 shows the detection of oleic acid remaining on cloth after incubation with increasing amounts of rGsCGTase/dextrin or alpha cyclodextrin. The results show that oleic acid was significantly removed from cloth by rGsCGTase/dextrin or alpha cyclodextrin.

Various modifications and variations of the described methods and system of the invention will be apparent to those skilled in the art without departing from the spirit and scope of the invention. Although the invention has been described in connection with specific preferred embodiments, it should be understood that the invention as claimed should not be unduly limited to such specific embodiments.

1. A method for removing oily stains from fabrics, comprising the steps of:
(i) identifying fabrics having oily stains; and
(ii) treating the fabrics with a washing solution comprising cyclomaltodextrin glucanotransferase (CGTase) and a substrate of starch or dextrin to produce cyclodextrins in situ;
wherein the cyclodextrins remove the oily stains from the fabrics.

2. The method of claim 1, wherein the washing solution further comprises a lypolytic enzyme.

3. The method of claim 2, wherein the lypolytic enzyme is a lipase or a cutinase.

4. The method of claim 2, wherein the oily stain comprises tryglycerides that are hydrolyzed to fatty acids by the lypolytic enzyme, and wherein the cyclodextrins prevent the deposition of the fatty acids on the fabric.

5. The method of claim 2, wherein the oily stain comprises tryglycerides that are hydrolyzed to fatty acids by the lypolytic enzyme, and the cyclodextrins remove the fatty acids from the fabric.

6. The method of claim 1, wherein the washing solution further comprises a surfactant, hydrolytic enzyme, builder, bleaching agent, bleach activator, bluing agent, fluorescent dye, caking inhibitor, masking agent, antioxidant, or solubilizer.

7. A method for removing oily stains from fabrics, comprising the steps of:
(i) identifying fabrics having oily stains; and
(ii) treating the fabrics with a washing solution comprising cyclodextrins;
wherein the cyclodextrins remove the oily stains from the fabrics.

8. The method of claim 7, wherein the washing solution further comprises a lypolytic enzyme.

9. The method of claim 8, wherein the lypolytic enzyme is a lipase or a cutinase.

10. The method of claim 8, wherein the oily stain comprises tryglycerides that are hydrolyzed to fatty acids by the lypolytic enzyme, and the cyclodextrins prevent the deposition of the fatty acids on the fabric.

11. The method of claim 8, wherein the oily stain comprises tryglycerides that are hydrolyzed to fatty acids by the lypolytic enzyme, and the cyclodextrins remove the fatty acids from the fabric.

12. The method of claim 7, wherein the washing solution further comprises a surfactant, hydrolytic enzyme, builder, bleaching agent, bleach activator, bluing agent, fluorescent dye, caking inhibitor, masking agent, antioxidant, or solubilizer.

13. A laundry composition for removing oily stains comprising tryglycerides from fabric, the composition comprising:
(i) a lypolytic enzyme for generating fatty acids from tryglycerides present in an oily stain; and
(ii) cyclodextrins for removing the fatty acids from the fabric or preventing the fatty acids from depositing on the fabric.

14. The laundry composition of claim 13, wherein the cyclodextrins are generated in situ using cyclomaltodextrin glucanotransferase (CGTase) and a substrate of starch or dextrin.

15. A laundry composition for removing oily stains comprising tryglycerides from fabric, the composition comprising:
(i) a lypolytic enzyme for generating fatty acids from tryglycerides present in an oily stain; and
(ii) glucanotransferase (CGTase) and a substrate of starch or dextrin for producing cyclodextrins for removing the fatty acids from the fabric or preventing the fatty acids from depositing on the fabric.

16. The composition of claim 13, wherein the CGTase is from Geobacillus stearothermophilus.

17. The composition of claim 13, wherein the CGTase has at least 90% sequence identity to the amino acid sequence of SEQ ID NO: 3.

18. The composition of claim 13, further comprising a a surfactant, hydrolytic enzyme, builder, bleaching agent, bleach activator, bluing agent, fluorescent dye, caking inhibitor, masking agent, antioxidant, or solubilizer.
